(19) United States
(12) Patent Application Publication
(10) Pub. No.: US 2015/0248777 A1
(43) Pub. Date: Sep. 3, 2015

(54) IMAGE PROCESSING APPARATUS, IMAGE FORMING APPARATUS, AND RECORDING MEDIUM

(71) Applicant: SHARP KABUSHIKI KAISHA, Osaka-shi, Osaka (JP)

(72) Inventors: Yohsuke Konishi, Osaka-shi (JP); Akihito Yoshida, Osaka-shi (JP); Hitoshi Hirohata, Osaka-shi (JP)

(73) Assignee: Sharp Kabushiki Kaisha, Osaka-shi, Osaka (JP)

(21) Appl. No.: 14/427,703

(22) PCT Filed: Aug. 21, 2013
(86) PCT No.: PCT/JP2013/072274

§ 371 Date: Mar. 12, 2015

(30) Foreign Application Priority Data
Sep. 18, 2012 (JP) 2012-204996

(51) Int. Cl. G06T 11/20; G06T 11/60

(52) U.S. Cl. CPC G06T 11/20; G06T 11/60; G06T 2210/32

(57) ABSTRACT

A file information generation section generates a draw command for causing a computer to carry out a process for switching, in accordance with an instruction from a user, between a first display state in which, in a case where the user specifies a part of an original text, the original text and translation information corresponding to the part of the original text, which part is specified by the user, are displayed; and a second display state in which the original text and the translation information corresponding to the original text are displayed at all times. This allows a browsing user to generate an image file in which a display mode of a translated word can be easily switched.

### TECHNICAL FIELD

The present invention relates to an image processing apparatus having a function of translating an original text contained in an image corresponding to image data, an image forming apparatus, and a storage medium storing a program for causing the image processing apparatus to operate.

### BACKGROUND ART

There is a conventionally known technique for (i) carrying out a character recognition process with respect to image data of a document, (ii) carrying out a translation process with respect to text data obtained by the character recognition process, and (iii) generating an image file (e.g., a PDF file) corresponding to an image (an image with a translation) where both an original text and a translated text are written.

For example, Patent Literature 1 discloses a technique for (i) obtaining image data containing a plurality of pieces of text information, (ii) obtaining corresponding information (a translated word(s)) corresponding to text information contained in the obtained image data, (iii) obtaining region information indicative of a region where the corresponding information is to be inserted in accordance with an arrangement of text lines containing the text information, and (iv) determining how the corresponding information is to be inserted, in accordance with the region information obtained. Note that the technique of Patent Literature 1 is arranged so that only a reference index is inserted between text lines and corresponding information (translated word) is inserted in a bottom margin in a case where a space between text lines in the image data is equal to or less than a predetermined level.

### CITATION LIST

### Patent Literatures

Patent Literature 1

Japanese Patent Application Publication, Tokukai, No. 2009-294788 A (Publication Date: Dec. 17, 2009)

Patent Literature 2

Japanese Patent Application Publication, Tokukaihei, No. 7-192086 (1995) A (Publication Date: Jul. 28, 1995)

Patent Literature 3

Japanese Patent Application Publication, Tokukaihei, No. 6-189083 (1994) A (Publication Date: Jul. 8, 1994)

### SUMMARY OF INVENTION

### Technical Problem

However, according to the technique of Patent Literature 1, not only text information of an original text but also text information of a translated word is inserted at all times. Thus, depending on preference of a user who browses an image file or an intended use of the image file, the user may feel annoyed or may be unable to use the image file by a method for use in accordance with the intended use.

However, according to the technique of Patent Literature 1, in order to erase a translated word inserted in an image file, it is necessary to turn off a function setting for providing translated words, and regenerate an image file containing no corresponding information (translated word) by reading a document again.

The present invention has been made in view of the problems, and an object of the present invention is to generate an image file in which a display mode (display or non-display) of a translated word can be easily switched in accordance with user's preference and an intended use of the image file.

### Solution to Problem

An image processing apparatus of the present invention includes: a text information obtaining section configured to obtain text information of an original text contained in an image corresponding to image data; a translation section configured to generate translation information of the original text by carrying out a translation process with respect to the original text in accordance with the text information; a draw command generation section configured to generate a draw command indicative of details of processes which are carried out by a computer so as to display the image corresponding to the image data; and a formatting process section configured to generate an image file in a predetermined format which image file contains the image data, the translation information, and the draw command, the draw command generated by the draw command generation section, including a draw command for causing the computer to carry out a process for switching (selecting), in accordance with an instruction from a user, between a first display state in which the original text is displayed while the translation information is not displayed, and in a case where the user specifies a part of the original text, the original text and the translation information corresponding to the part of the original text, which part is specified by the user, are displayed; and a second display state in which the original text and the translation information corresponding to the original text are displayed at all times.

### Advantageous Effects of Invention

The arrangement allows a user who browses an image file to generate the image file in which a display state can be easily switched between the first display state and the second display state in accordance with user's preference and an intended use of the image file. Accordingly, it is possible to provide an image file that is easy for a user to use and browse.

### BRIEF DESCRIPTION OF DRAWINGS

FIG. 1 is a block diagram schematically illustrating an arrangement of an image processing apparatus according to one embodiment of the present invention and an image forming apparatus including the image processing apparatus.

FIG. 2 is a block diagram illustrating an internal configuration of a document detection section of the image processing apparatus illustrated in FIG. 1.

FIG. 3 is a block diagram showing an example of a file generation section of the image processing apparatus illustrated in FIG. 1.

FIG. 4 is a diagram showing a display state of an image displayed in accordance with an image file generated by the image processing apparatus illustrated in FIG. 1. (a) of FIG. 4 shows an example of display of a pop-up display state. (b) of FIG. 4 shows an example of display of a translated-word display state.

FIG. 5 is a flow chart of a process carried out in an image transmitting mode by the image forming apparatus illustrated in FIG. 1.

FIG. 6 is a diagram showing an example of information (a draw command), embedded in the image file generated by the image processing apparatus illustrated in FIG. 1, for switching between the pop-up display state and the translated-word display state.

FIG. 7 is a diagram showing an example of information (a draw command), embedded in the image file generated by the image processing apparatus illustrated in FIG. 1, for switching between the pop-up display state and the translated-word display state.

FIG. 8 is a diagram showing an example of information (a draw command), embedded in the image file generated by the image processing apparatus illustrated in FIG. 1, for displaying a switching button.

FIG. 9 is a diagram showing a relationship between each layer of the image file generated by the image processing apparatus illustrated in FIG. 1 and a translated-word display state.

FIG. 10 is a diagram showing an example of information (a draw command), embedded in the image file generated by the image processing apparatus illustrated in FIG. 1, for specifying whether or not it is necessary to print the switching button.

FIG. 11 is a diagram showing an example of information (a draw command), embedded in the image file generated by the image processing apparatus illustrated in FIG. 1, for specifying an initial translated-word display state.

FIG. 12 is a diagram showing an example of a method for assigning a label to each of a plurality of pages of the image file generated by the image processing apparatus illustrated in FIG. 1.

FIG. 13 is a diagram showing a modified example of the method for assigning a label to each of a plurality of pages of the image file generated by the image processing apparatus illustrated in FIG. 1.

FIG. 14 is a diagram showing an example of information (a draw command), embedded in the image file generated by the image processing apparatus illustrated in FIG. 1, for specifying a method for displaying the switching button.

FIG. 15 is a diagram showing an example of a display state of the switching button in accordance with the information of FIG. 14.

FIG. 16 is a block diagram showing a modified example of the file generation section of the image processing apparatus illustrated in FIG. 1.

FIG. 17 is a flow chart of a file format determination process carried out by the image processing apparatus illustrated in FIG. 1.

FIG. 18 is a block diagram showing an example arrangement in a case where the present invention is applied to a color image reading apparatus.

### DESCRIPTION OF EMBODIMENTS

An embodiment of the present invention is described below. Note that the present embodiment mainly discusses an example of a case where the present invention is applied to a digital color multifunction peripheral. Note, however, that the present invention is applicable not only to the digital color multifunction peripheral but also to any apparatus that has a function of generating an image file containing image data of a document and information on a translation into which an original text contained in the document is translated.

(1) Overall Structure of Image Forming Apparatus 1

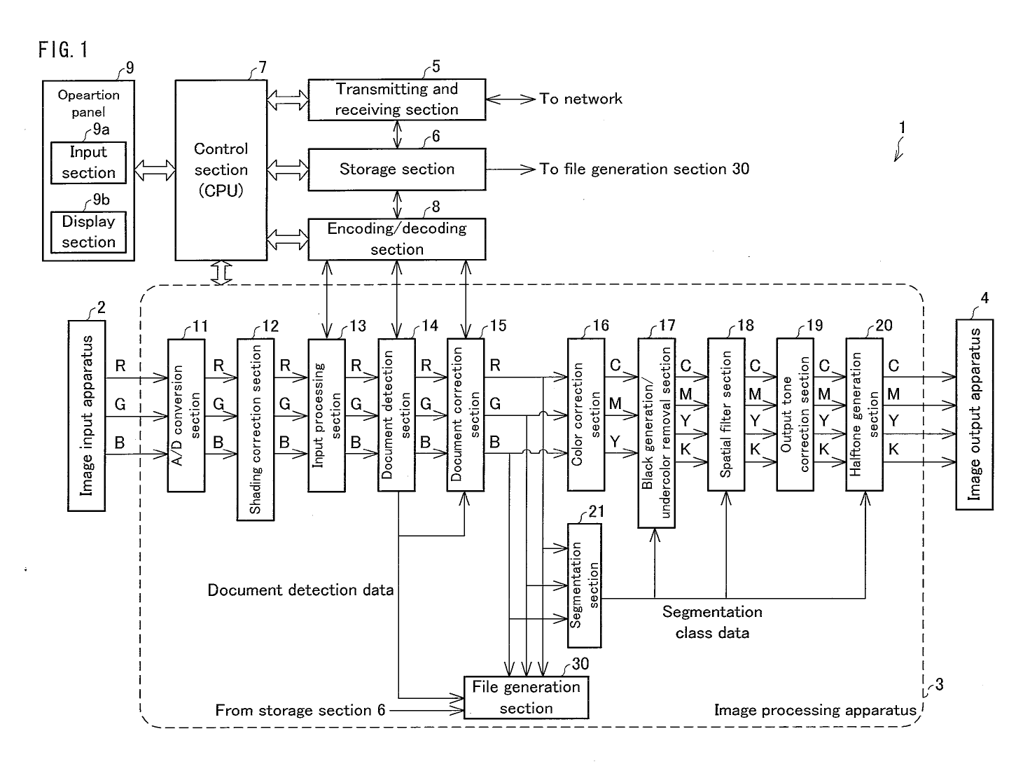

FIG. 1 is a block diagram schematically illustrating an arrangement of an image forming apparatus 1 including an image processing apparatus 3 according to the present embodiment.

As illustrated in FIG. 1, the image forming apparatus includes an image input apparatus 2, the image processing apparatus 3, an image output apparatus 4, a transmitting and receiving section 5, a storage section 6, a control section 7, an encoding/decoding section 8, and an operation panel 9. Further, the image processing apparatus includes an A/D conversion section 11, a shading correction section 12, an input processing section 13, a document detection section 14, a document correction section 15, a color correction section 16, a black generation/undercolor removal section 17, a spatial filter section 18, an output tone correction section 19, a halftone generation section 20, a segmentation section 21, and a file generation section 30.

The image forming apparatus 1 is capable of carrying out (i) a printing mode in which an image in accordance with image data read by the image input apparatus 2 is printed on a recording material by the image output apparatus 4, and (ii) an image transmitting mode in which image data read by the image input apparatus 2 is transmitted, by the transmitting and receiving section 5, to another device or apparatus communicably connected via a network or the like.

The image input apparatus 2 is a scanner including a CCD (Charge Coupled Device) line sensor, and converts light reflected from a document into electric signals (image data) of R (red), G (green) and B (blue) color components. Note that the image input apparatus 2 is not specifically limited in arrangement, but may be any image input apparatus arranged to read a document and obtain image data of the document, for example, an image input apparatus arranged to read a document placed on a scanner platen or an image input apparatus arranged to read a document being carried by document carrying means (document feed system).

In the printing mode (printing operation), the image processing apparatus 3 outputs CMYK (C: cyan, M: magenta, Y: yellow, K: black) image data to the image output apparatus 4. The CMYK image data is obtained by subjecting image data inputted from the image input apparatus 2 to various kinds of image processing.

In the image transmitting mode (transmitting operation), the image processing apparatus 3 carries out not only the various kinds of image processing on the image data inputted from the image input apparatus 2 but also a character recognition process and a translation process based on the image data. The image processing apparatus 3 also generates an image file by use of results of the character recognition process and the translation process, and then transmits the image file to a storage destination or transmission destination that is specified by a user. Note that blocks in the image processing apparatus 3 will be discussed in detail later.

The image output apparatus 4 outputs (prints), on a recording material (e.g., paper), an image of the image data inputted from the image processing apparatus 3. The image output apparatus 4 is not specifically limited in arrangement. It is possible to use, for example, an electrophotographic or ink-jet image output apparatus, as the image output apparatus 4.

The transmitting and receiving section 5 connects the image forming apparatus 1 to a network, and carries out data communication with an external device(s)/apparatus(es) (e.g., a personal computer, a server, a display device, other digital multifunction peripheral, and/or a facsimile machine) that is communicably connected to the network. The transmitting and receiving section 5 is not specifically limited in arrangement, but may be any transmitting and receiving section that has a function of communicating with an external device(s)/apparatus(es) via a network, for example, a transmitting and receiving section that is configured of a modem or a network card and connects the image forming apparatus 1 to a network via a network card, LAN cable or the like.

The storage section 6 is storage means (storage device) in which various kinds of data (image data, etc.) handled (processed) in the image forming apparatus 1 is stored. The storage section 6 is not specifically limited in configuration, and it is possible to use a data storage device such as a hard disk.

The encoding/decoding section 8 is configured to encode image data being processed by the image processing apparatus 3 at the time when the image data is to be stored in the storage section 6, in a case where an encoding mode is selected. In other words, in a case where the encoding mode is selected, the encoding/decoding section 8 first encodes the image data and then stores this image data in the storage section 6. On the other hand, in a case where the encoding mode is not selected, the image data is not encoded. In this case, the image data is stored in the storage section 6, without being processed by the encoding/decoding section 8. Note that whether to select the encoding mode is selected by a user by use of, for example, the operation panel 9. The encoding/decoding section 8 also decodes image data read from the storage section 6, in a case where this image data is encoded.

The operation panel 9 includes an input section 9a and a display section 9b. The input section 9a receives an input of an instruction from the user to the image forming apparatus 1 and transmits the input to the control section 7. The input section 9a has, for example, a key operation button. The display section 9b is display means for displaying information in accordance with the instruction of the control section 7. The display section 9b is exemplified by, for example, a liquid crystal display. Note that the input section 9a and the display section 9b are not specifically limited provided that the input section 9a and the display section 9b can carry out the respective functions described above. For example, it is possible to use a touch panel in which the respective functions of the input section 9a and the display section 9b are integrated.

The control section 7 is a process controlling device (control means) for controlling operations of sections provided in the image processing apparatus 3. Note that the control section 7 is a device that is made of, for example, a CPU (Central Processing Unit) or the like, and controls the operations of the sections in the image forming apparatus 1, based on, for example, information inputted through the operation panel 9, and a program and/or various data stored in storage means such as a ROM (not illustrated). Further, the control section 7 controls a data flow inside the image forming apparatus 1 and data reading and writing from or to the storage section 6.

(2) Structure of Image Processing Apparatus 3 (2-1) Printing Mode

Next, the following discusses in more detail blocks included in the image processing apparatus 3 and operations of the image processing apparatus 3 in the printing mode.

In the printing mode, as illustrated in FIG. 1, first, the A/D conversion section 11 converts RGB analog signals inputted from the image input apparatus 2 into digital signals and outputs the digital signals to the shading correction section 12.

The shading correction section 12 receives the digital RGB signals from the A/D conversion section 11 and subjects the digital RGB signals to a process for removing various distortions produced in an illumination system, an image-focusing system and an image-sensing system of the image input apparatus 2. Then, the shading correction section 12 outputs the processed digital RGB signals to the input processing section 13.

The input processing section 13 subjects, to various processes such as a gamma correction, the RGB signals from which the various distortions are removed in the shading correction section 12. The input processing section 13 also stores, in the storage section 6, the image data having been subjected to the various processes.

The document detection section 14 reads out the image data which the input processing section 13 stored in the storage section 6, and detects a skew angle of a document image in the image data. Then, the document detection section 14 transmits the detected skew angle to the document correction section 15. The document correction section 15 reads out the image data stored in the storage section 6 and carries out skew correction of the document, in accordance with the skew angle transmitted from the document detection section 14.

After the skew correction is carried out by the document correction section 15, the document detection section 14 also reads out the image data stored in the storage section 6, and determines a top-to-bottom direction (orientation) of the document based on the image data. The document detection section 14 further transmits a determination result to the document correction section 15. Then, the document correction section 15 reads out the image data stored in the storage section 6 and carries out a top-to-bottom direction correcting process, in accordance with the determination result of the top-to-bottom direction of the document.

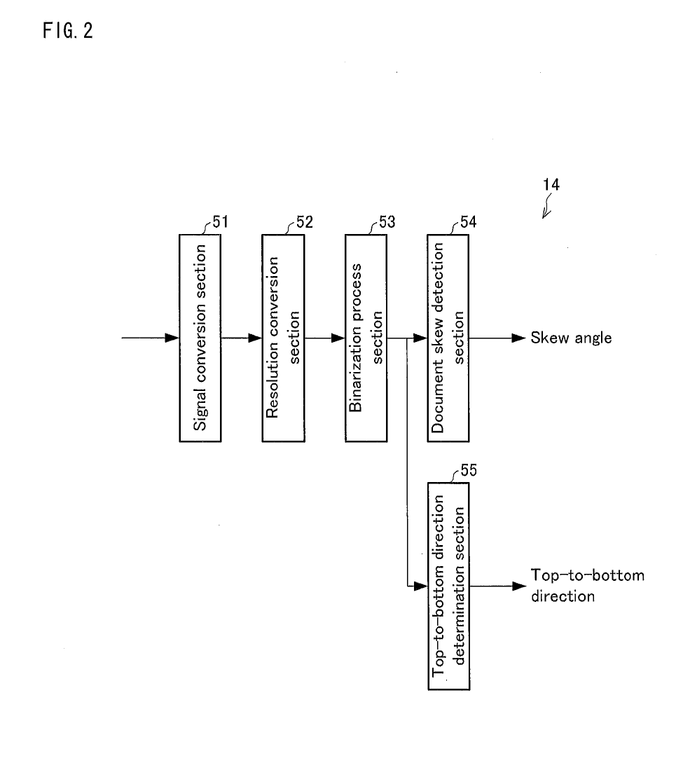

FIG. 2 is a block diagram schematically illustrating a configuration of the document detection section 14. As illustrated in FIG. 2, the document detection section 14 includes a signal conversion section 51, a resolution conversion section 52, a binarization process section 53, a document skew detection section 54, and a top-to-bottom direction determination section 55.

The signal conversion section 51 converts the image data that is inputted from the storage section 6, into a lightness signal or a luminance signal. For example, the signal conversion section 51 converts the RGB signals (image data) to a luminance signal Y by calculating Yi=0.30 Ri+0.59 Gi+0.11 Bi, where: Y is a luminance signal of each pixel; R, G, and B are respective color components of the RGB signals of each pixel; and a subscript i is a value (i is an integer equal to or greater than 1) given to each pixel. Alternatively, the RGB signals may be converted into a CIE1976L*a*b* signal (CIE: Commission International de l'Eclairage, L*: Lightness, a* and b*:chromaticity).

The resolution conversion section 52 converts, into a low resolution, a resolution of the image data (luminance value (luminance signal) or lightness value (lightness signal)) having been converted into the achromatic image data by the signal conversion section 51. For example, image data read at 1200 dpi, 750 dpi, or 600 dpi is converted into image data of 300 dpi. A method for converting the resolution is not specifically limited. It is possible to use, for example, a conventionally known method such as a nearest neighbor method, a bilinear method, and a bicubic method.

The binarization process section 53 binarizes the image data by comparing the image data whose resolution is converted into a low resolution with a predetermined threshold. For example, in a case where the image data is 8-bit image data, the threshold is set to 128. Alternatively, an average value of densities (pixel values) in a block made of a plurality of pixels (e.g., 5 pixels×5 pixels) may be set as the threshold.

The document skew detection section 54 detects a skew angle of the document relative to a scanning area in image reading, based on the image data that has been binarized by the binarization processing section 53. Then, the document skew detection section 54 outputs a detection result to the document correction section 15.

A method of detecting the skew angle is not specifically limited. As the method, various conventionally known methods can be used. For example, a method described in Patent Literature 2 may be used. In this method, a plurality of boundary points between black pixels and white pixels (e.g., coordinates of black/white boundary points of an upper edge of each text) are extracted from the binarized image data, and coordinate data of a line of points for the boundary points is obtained. Then, based on the coordinate data of the line of points, a regression line is obtained and a regression coefficient b of the regression line is calculated according to Formula (1) below:

$$\begin{matrix}[ Formulae 1 ] & \\ b = \frac{Sxy}{Sx} & Formula ( 1 ) \\ \begin{matrix}Sx = {\sum }_{i = 1}^{n} {( {x}_{i} - x )}^{2} \\ = {\sum }_{i = 1}^{n} {x}_{i}^{2} - {( {\sum }_{i = 1}^{n} {x}_{i} )}^{2} / n\end{matrix} & Formula ( 2 ) \\ \begin{matrix}Sy = {\sum }_{i = 1}^{n} {( {y}_{i} - y )}^{2} \\ = {\sum }_{i = 1}^{n} {y}_{i}^{2} - {( {\sum }_{i = 1}^{n} {y}_{i} )}^{2} / n\end{matrix} & Formula ( 3 ) \\ \begin{matrix}Sxy = {\sum }_{i = 1}^{n} ( {x}_{i} - x ) ( {y}_{i} - y ) \\ = {\sum }_{i = 1}^{n} {x}_{i} {y}_{i} - ( {\sum }_{i = 1}^{n} {x}_{i} ) ( {\sum }_{i = 1}^{n} {y}_{i} ) / n\end{matrix} & Formula ( 4 )\end{matrix}$$

Note that: Sx is an error sum of squares of a variable x and Sy is an error sum of squares of a variable y; and Sxy is a sum of products each obtained by multiplying a residual of x by a residual of y. In other words, Sx, Sy and Sxy are represented by the above formulae (2) to (4).

Further, by using the regression coefficient b calculated as described above, a skew angle θ is calculated according to the following formula (5):

tan θ=b Formula (5)

The top-to-bottom direction determination section 55 determines a top-to-bottom direction of the document in the image data stored in the storage section 6, based on the image data that has been binarized by the binarization processing section 53. Then, the top-to-bottom direction determination section 55 outputs a determination result to the document correction section 15.

A method for determining the top-to-bottom direction is not specifically limited. As the method, it is possible to use various conventionally known methods. For example, a method disclosed in Patent Literature 3 may be used.

According to the method of Patent Literature 3, the character recognition process is carried out based on the image data and texts in the document are clipped (cropped) one by one so that a pattern is developed for each text. Note that this process is carried out by using the above binarized image data whose resolution is reduced to 300 dpi. The character recognition process is not necessarily carried out for all the texts. For example, by extracting a predetermined number of texts, the character recognition process may be carried out on the texts extracted.

Subsequently, a characteristic of a text pattern developed as above is matched (compared) with text pattern information made into a database in advance. A matching method may be arranged as follows: first, a text pattern of each text clipped from the image data is superimposed on database text patterns, and black and white are compared for each pixel; then, the text in the image data is distinguished as a text of a database text pattern having pixels to which all pixels of the text pattern of the text in the image data match, among from the database text patterns. Note that in a case where there is no database text pattern having pixels to which all pixels of the text pattern of the text in the image data match, the text in the image data is determined to be a text of a database text pattern having pixels to which the largest number of pixels of the text pattern of the text in the image data match. However, unless a ratio of the number of pixels that match to pixels in any of the database text patterns does not reach a predetermined matching ratio, it is determined that the text is undistinguishable.

The character recognition process is carried out for each of cases where the image data is rotated by 90°, 180°, and 270°. Then, for each of the cases where the image data is rotated by 0°, 90°, 180°, and 270°, the number of distinguishable texts is calculated. Then, a rotation angle which has the largest number of distinguishable texts is determined to be a text direction, that is, the top-to-bottom direction of the document. Further, a rotation angle is determined which rotation angle causes the top-to-bottom direction of the document image in the image data to coincide with a normal top-to-bottom direction. More specifically, on an assumption that an angle in a clockwise direction with respect to the normal top-to-bottom direction is a positive angle, the rotation angles are defined as follows: (i) 0° in a case where the top-to-bottom direction (reference direction) of the document image in the image data coincides with the normal top-to-bottom direction; (ii) 90° in a case where the top-to-bottom direction of the document image in the image data differs from the normal top-to-bottom direction by −90°; (iii) 180° in a case where the top-to-bottom direction of the document image in the image data differs from the normal top-to-bottom direction by −180°; and (iv) 270° in a case where the top-to-bottom direction of the document image in the image data differs from the normal top-to-bottom direction by −270°. The document detection section 14 outputs, to the document correction section 15 (see FIG. 1), the above rotation angle as the determination result of the top-to-bottom direction. Then, the document correction section 15 subjects the image data stored in the storage section 6, to a rotating process in accordance with the above rotation angle.

In the document detection section 14 described above, first, the image data having been processed by the input processing section 13 is read out from the storage section 6 and inputted into the signal conversion section 51. Then, the image data is subjected to processes respectively carried out by the signal conversion section 51, the resolution conversion section 52, and the binarization process section 53. Then, a skew angle is detected by the document skew detection section 54. Subsequently, the document correction section 15 reads out the image data stored in the storage section 6, and carries out skew correction on the image data in accordance with a detection result of the document skew detection section 54. The document correction section 15 further stores, in the storage section 6, the image data having been subjected to the skew correction. Thereafter, the image data having been subjected to the skew correction is read out from the storage section 6 and inputted to the signal conversion section 51. Then, the image data is subjected to processes respectively carried out by the signal conversion section 51, the resolution conversion section 52, and the binarization process section 53. Further, the top-to-bottom direction determination section 55 determines a top-to-bottom direction. After this determination, the document correction section 15 reads out the image data (the image data having been subjected to the skew correction) stored in the storage section 6 and carries out orientation correction on the image data as necessary in accordance with a determination result of the top-to-bottom direction determination section 55.

Note that in a case where the encoding mode is selected, the encoding/decoding section 8 encodes the image data that is outputted from the input processing section 13 or the document correction section 15 and that is to be stored in the storage section 6, and then this encoded image data is stored in the storage section 6. Further, in the case where the encoding mode is selected, the encoding/decoding section 8 decodes the image data that is read out from the storage section 6 and that is to be inputted into the document detection section 14 or the document correction section 15, and then this decoded image data is inputted into the document detection section 14 or the document correction section 15.

The color correction section 16 converts the image data received from the document correction section 15 and containing the RGB signals into CMY (C: cyan, M: magenta, Y: yellow) image data. These CMY colors are complementary colors of the RGB signals. In addition, the color correction section 16 carries out a process for enhancing (improving) reproducibility.

The segmentation process section 21 segments each of the pixels of an image of the image data received from the document correction section 15 into one of a black text region, a color text region, a halftone dot region, and a photograph region (continuous tone region). Based on a segmentation result, the segmentation process section 21 outputs segmentation class data (segmentation class signal) to the black generation/undercolor removal section 17, the spatial filter section 18, and the halftone generation section 20. The segmentation class data is indicative of a region to which the each pixel belongs. A method of the segmentation process is not specifically limited, and it is possible to use a conventionally known method. The black generation/undercolor removal section 17, the spatial filter section 18, and the halftone generation section 20 each carry out a process suitable for each of the above regions, in accordance with the inputted segmentation class signal.

The black generation/undercolor removal section 17 carries out a black generation process by which a black (K) signal is generated from color-corrected three color signals of CMY, and carries out an undercolor removal process for subtracting the K signal from the original CMY signals so as to generate new CMY signals. In this way, the three color signals of CMY are converted into four color signals of CMYK.

The spatial filter section 18 carries out, in accordance with the segmentation class data, a spatial filter process (edge enhancement process and/or smoothing process) by use of a digital filter, with respect to image data of the CMYK signals inputted from the black generation/under color removal section 17, so that a spatial frequency characteristic of the image data is corrected. This makes it possible to reduce a blur or a granularity deterioration of an output image.

The output tone correction section 19 carries out an output y correction process for outputting to a recording material such as a sheet or the like, and then outputs image data which has been subjected to the output y correction process to the halftone generation section 20.

The halftone generation section 20 carries out, on the image data, a tone reproduction process (halftone generation) so that an image can ultimately be separated into pixels to reproduce each tone.

The image data having been subjected to the processes described above and outputted from the halftone generation section 20 is temporarily stored in a memory (not illustrated). Then, the image data stored is read out at a predetermined timing and inputted into the image output apparatus 4. The image output apparatus 4 carries out printing in accordance with the image data.

(2-2) Image Transmitting Mode

Next, the following explains in more detail an operation of the image processing apparatus 3 in the image transmitting mode, with reference to FIG. 1. Note that respective operations of the A/D conversion section 11, the shading correction section 12, and the input processing section 13 are the same as those in the printing mode. Note that the image transmitting mode is arranged in a manner such that the image data having been processed by the input processing section 13 is temporarily stored in the storage section 6.

As described earlier, the image transmitting mode has a regular mode and a simple mode. In a case where the regular mode is selected, the document detection section 14 and the document correction section 15 carry out, on the image data stored in the storage section 6, skew angle detection, skew correction, top-to-bottom direction determination, and top-to-bottom direction correction as in the printing mode. Then, the document correction section 15 outputs, to the file generation section 30, the image data which has been subjected to the skew correction and the top-to-bottom direction correction.

On the other hand, in a case where not the regular mode but the simple mode is selected, the document detection section 14 carries out the skew angle detection and the top-to-bottom direction determination, but the document correction section 15 does not carry out the skew correction and the top-to-bottom direction correction. In the simple mode, the document correction section 15 reads out the image data from the storage section 6, and then directly outputs, to the file generation section 30, the image data that has not been subjected to the skew correction and the top-to-bottom direction correction.

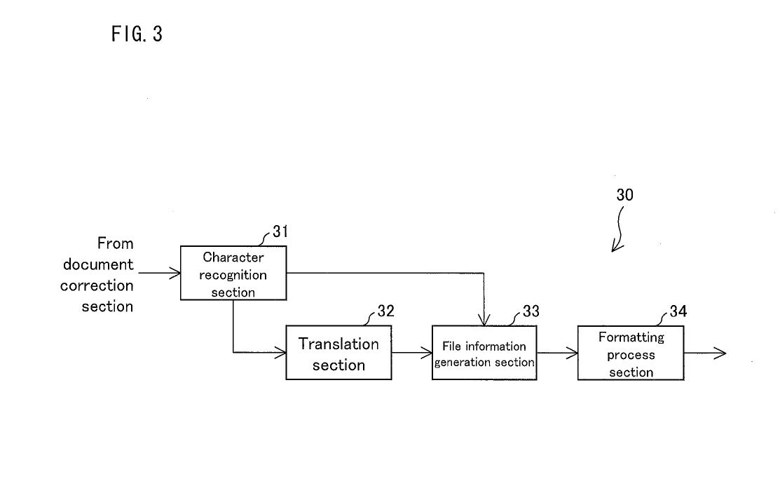

As illustrated in FIG. 3, the file generation section 30 includes a character recognition section (text information obtaining section) 31, a translation section 32, a file information generation section (draw command generation section) 33, and a formatting process section 34. In a case where the image transmitting mode is selected, the file generation section 30 not only carries out a character recognition process and a translation process but also generates an image file that is to be transmitted to a transmission destination or storage destination which is specified by a user.

The character recognition section 31 converts a resolution of inputted image data to a low resolution (e.g., 300 dpi) and binarizes the image data whose resolution has been converted into the low resolution, so as to generate binarized image data. The character recognition section 31 carries out a character recognition process with use of this binarized image data. Further, the character recognition section 31 generates text (original text) data contained in an image (document) corresponding to the image data, in accordance with a result of the character recognition process, and then outputs this text data to each of the translation section 32 and the file information generation section 33. Note that this text data contains a character code of each text and positional information of each text.

The character recognition process carried out by the character recognition section 31 is not specifically limited in method, but any conventionally known method can be employed. For example, character recognition may be carried out by first extracting features of respective texts in the binarized image data and then comparing the features with dictionary data (text database). Note that the dictionary data used in the character recognition section 31 is stored in the storage section 6.

Further, the character recognition section 31 not only transmits the above text data but also forwards the inputted image data, to the file information generation section 33. In other words, the file information generation section 33 receives the text data obtained by the character recognition process and the image data indicative of the document, from the character recognition section 31.

The translation section 32 carries out the translation process of a language of the text data that has been transmitted from the character recognition section 31. More specifically, the translation section 32 compares the text data with dictionary data (word sense database) including word sense information, and obtains translated words corresponding to the language (original text) in the document. Note that the dictionary data used by the translation section 32 is stored in the storage section 6.

Further, in the present embodiment, a plurality of word sense databases are stored in the storage section 6 so that processing contents can be switched in accordance with a translation mode. For example, in the storage section 6, various kinds of databases are stored. Such various kinds of databases includes, for example, an English-to-Japanese translation database for translating English to Japanese, an English-to-Chinese translation database for translating English to Chinese, etc. Then, the translation section 32 carries out the translation process with reference to the English-to-Japanese translation database in the storage section 6, in a case where an English-to-Japanese mode for translating English to Japanese is selected by a user. Meanwhile, in case where an English-to-Chinese mode for translating English to Chinese is selected by a user, the translation section 32 carries out the translation process with reference to the English-to-Chinese translation database in the storage section 6 (in other words, the translation section 32 switches databases to be referred to, in accordance with the translation mode).

Furthermore, in the present embodiment, for one translation mode, a plurality of word sense databases are stored in the storage section 6 so as to correspond to respective translation levels (simple, standard, detailed). For example, in the storage section 6, a simple-level English-to-Japanese translation database, a standard-level English-to-Japanese translation database, and a detailed-level English-to-Japanese translation database are stored. The translation section 32 carries out the translation process with reference to a database of a level selected by a user. Note that the “simple level” means a level at which only difficult words are translated; the “standard level” means a level at which words from difficult words to high-school-level words are translated; and the “detailed level” means a level at which words from difficult words to basic words are translated.

The file information generation section 33 generates file information, containing a plurality of layers (layer information) and a draw command, for the subsequent formatting process section 34 to generate an image file (PDF file).

More specifically, the file information generation section 33 generates the following layers: (i) a layer (document image layer) indicative of a document image based on the document image data transmitted from the character recognition section 31; (ii) a layer (text layer) indicative of an invisible text based on the document original text data transmitted from the character recognition section 31; (iii) a layer (translated-word layer) for displaying translated words based on a result of translation carried out by the translation section 32; and (iv) a layer (pop-up layer) for displaying translation information of a part of translated words which is in accordance with user operation.

Note that the invisible text is data for superimposing (or embedding), on (or in) the document image data, recognized characters and words as text information in an invisible form in appearance. For example, in the case of a PDF file, an image file in which an invisible text is added to document image data is generally used. The present embodiment discusses an example in which text data in accordance with a result of character recognition is embedded as an invisible text in an image file. Note, however, the present embodiment is not limited to such an example, but may be arranged such that text data in accordance with a result of character recognition is embedded as a visible text in an image file.

The translated-word layer is text data including (i) a translated text portion having a visible translated text that corresponds to an original text in the document image and (ii) an invisible portion that is a portion other than the translated text portion. In other words, unlike the invisible text, the translated-word layer is visible text data that is to be superimposed on the document image data in the form that allows a user to see the translated words. Note that according to the present embodiment, the file information generation section 33 generates the translated-word layer in which a position (e.g., a space that is between lines of the original text and adjacent to the original text) of the translated text is defined so that a user can compare the translated text and the original text corresponding to the translated text. Note that as a method for defining the position of the translated text relative to a position of the original text, various conventionally employed methods may be used. For example, Patent Literature 1 describes such a method in paragraphs [0063] through [0067]. The method described in Patent Literature 1 is a method of calculating, by an information insertion control section, a region where a translated text can be inserted.

The pop-up layer is a layer for, in a case where a user carries out, on a display screen on which the document image is displayed in a pop-up display state (described later) (display state in which the document image is displayed while no translation information is displayed), an operation to move a cursor (mouse pointer, indication position specifying image) (mouseover operation) with respect to a part of the document image, displaying translated words corresponding to a part of the original text in accordance with a position of indication by the cursor.

The file information generation section 33 also functions as a draw command generating section that generates a draw command to be embedded in an image file that is to be generated in the subsequent formatting process section 34. This draw command is a command that is used for instructing a computer (i) as to display conditions at the time when an image in accordance with the image file is displayed on a display screen of the computer, (ii) as to printing conditions at the time when the image of the image file is to be printed, and/or (iii) as to the like.

The formatting process section 34 is a block for generating an image file that is formatted in predetermined format data, in accordance with the image data transmitted from the file information generation section 33. Note that the present embodiment discusses a case where the formatting process section 34 generates an image file in a PDF format (PDF file). Note, however, that a format in which an image file is generated by the formatting process section 34 is not limited to the PDF format.

More specifically, the formatting process section 34 carries out a process for generating an image file where the layers and the draw command that are generated by the file information generation section 33 are embedded. In other words, in the image file generated by the formatting process section 34, the document image layer, the text layer, the translated-word layer, and the pop-up layer are included, and the draw command is embedded, the draw command indicating details of processes which are carried out by the computer so as to display an image corresponding to the image file (e.g., display conditions and/or printing conditions of each layer).

Note that according to the present embodiment, the file information generation section 33 causes the draw command to include an initial display command, a button display command, a switch command, a printing prohibition command, a batch processing command, and the like.

The initial display command is a command indicative of display conditions in a case where a user inputs a display instruction with respect to an image file (in a case where the user opens the image file).

According to the present embodiment, the initial display command is set to display the pop-up display state in which, in a case where the user inputs the display instruction with respect to the image file, the translated-word image is not displayed but only the document image is displayed, and the pop-up layer in accordance with a position of indication by a user's mouseover operation is displayed in accordance with the mouseover operation. In other words, according to the present embodiment, the initial display command is a command to instruct the computer to cause transition to the pop-up display state (first display state), in which the translated-word layer is not displayed but only the document image is displayed, in a case where the display instruction is inputted.

Note that the present embodiment sets the initial display state (display state in a case where the user inputs the display instruction) as the pop-up display state. Note, however, that the initial display state may be set not only as the pop-up display state but also as a translated-word display state (second display state). The translated-word display state is a display state in which the invisible text is provided so as to be superimposed on the document image and the translated-word layer is displayed.

The button display command is a command to instruct the computer to display a switching (selecting) button (display switching button) together with the document image, while the image file is open.

The switch command is a command to instruct the computer to switch between the pop-up display state (first display state) and the translated-word display state (second display state) in a case where a user clicks the switching button (makes a button operation) so as to give a switch instruction.

The printing prohibition command is a command to instruct the computer not to print the switching button in a case where a user gives a print instruction with respect to the image file.

The batch processing command is a command to instruct the computer to switch between the translated-word display state and the pop-up display state for all pages in a case where the document image is made of a plurality of pages and a click is made on a switching button displayed with any of the plurality of pages.

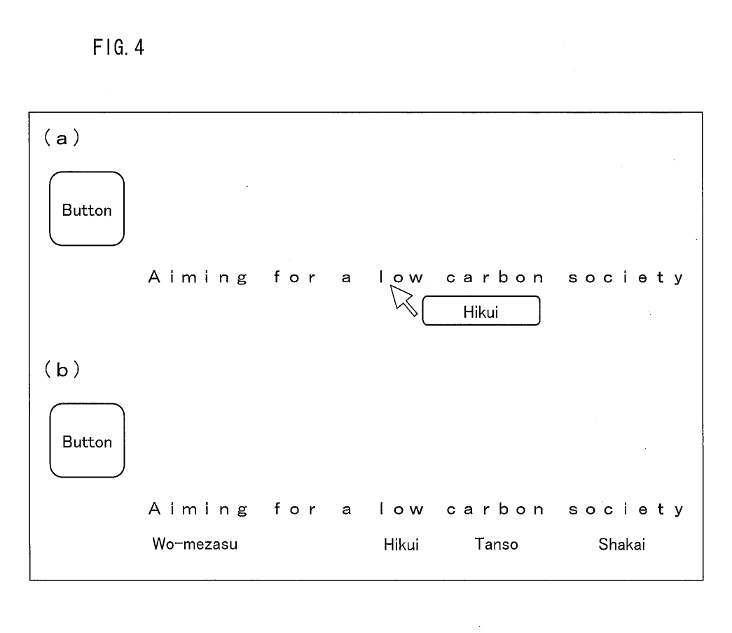

FIG. 4 shows examples of display of the pop-up display state and the translated-word display state. (a) of FIG. 4 shows the example of display of the pop-up display state. (b) of FIG. 4 shows the example of display of the translated-word display state.

According to the present embodiment, the pop-up display state is set to be selected in the initial display state. Thus, in a case where a user carries out an operation to open the image file, the original text (English) of the document image of the image file and the translated words corresponding to a position in the original text which position is indicated by the cursor (position on which a mouseover is performed) are pop-up displayed as illustrated in (a) of FIG. 4. As illustrated in (a) of FIG. 4, the switching button is also displayed in a part of or around the document image.

Next, when a user clicks the switching button illustrated in (a) of FIG. 4, then the pop-up display state as illustrated in (a) of FIG. 4 is switched to the translated-word display state as illustrated in (b) of FIG. 4.

In the translated-word display state, the original text (English) of the document image of the image file and the translated words (Japanese) corresponding to the original text in the translated-word layer are displayed alongside each other. In the translated-word display state as illustrated in (b) of FIG. 4, the switching button is also displayed. When a user clicks the switching button illustrated in (b) of FIG. 4, the translated-word display state as illustrated in (b) of FIG. 4 is switched to the pop-up display state as illustrated in (a) of FIG. 4.

When a switching button displayed on any of pages is clicked, the translated-word display state and the pop-up display state are commonly switched for all the pages. For example, when the pop-up display state is switched to the translated-word display state by a click made by a user on a switching button on the first page, display for second and subsequent pages is carried out also in the translated-word display state.

Further, in a case where a user inputs a print command for a document image of the image file while this document image is being displayed, the switching button is set by the printing prohibition command not to be printed out on the display screen even in a case where the switching button is being displayed.

The formatting process section 34 stores the image file generated as described above, in the storage section 6. Then, the transmitting and receiving section 5 transmits the image file stored in the storage section 6 to a transmission destination or storage destination which is specified by a user.

(2-3) Example Process in Image Transmitting Mode

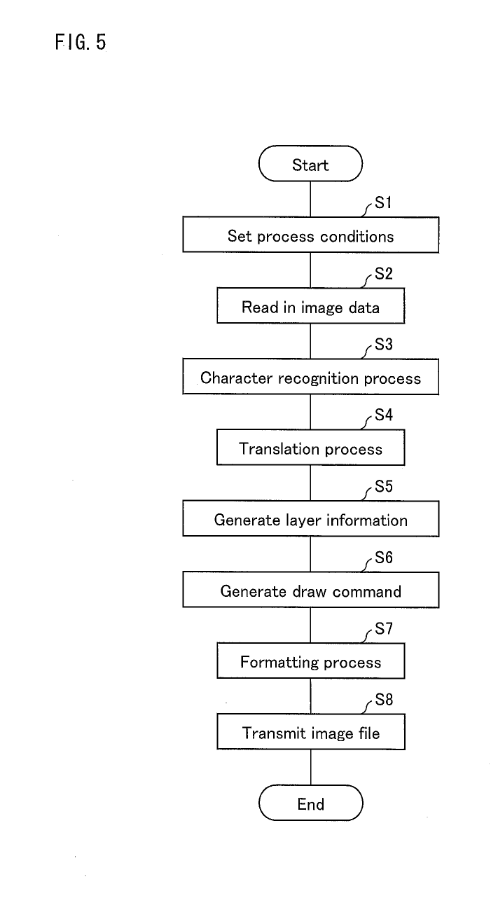

Next, the following discusses a flow of a process in the image transmitting mode. FIG. 5 is a flow chart of a process carried out in the image transmitting mode of the image forming apparatus 1.

The control section 7 sets process conditions of the image transmitting mode in accordance with an instruction that is inputted by a user by use of the operation panel 9 (S1).′S7

In this step of S1, the user is to select whether or not to perform the translation process. In a case where the user selects to perform the translation process, the control section 7 causes the display section 9b to display a screen urging the user to input an instruction to select whether or not to control the display state (translated-word display state/pop-up display state) of a result of translation, and causes the user to select whether or not to control the display state of the result of translation.

In a case where the user selects to control the display state of the result of translation, the control section 7 causes the display section 9b to display a screen urging the user to input an instruction to select the following items, and causes the user to select the following items:

(a) whether or not to display the result of translation when the file is opened (which of the translated-word display state and the pop-up display state is to be set as the display state when the file is opened);

(b) a language into which the original text is to be translated (e.g., Japanese, Chinese, English, or the like);

(c) a translation level (e.g., simple, standard, detailed, or the like);

(d) a color in which the result of translation is to be displayed (a color in which the result of translation is to be displayed may be set for each translation level, or the result of translation may be displayed in a color that is set in advance in accordance with the translation level); and

(e) a display mode of the image file (simple mode/regular mode)

Note that in a case where the user selects not to control the display state of the result of translation, the control section 7 causes the display section 9b to display a screen urging the user to select the above (e).

The control section 7 also causes the display section 9b to display a screen for causing the user to input or select an address of a transmission destination of the image file, and receives an instruction from the user on the address of the transmission destination. Note that the image file may be stored by causing the control section 7 to receive an instruction from the user on a storage destination of the image file by causing the display section 9b to display a screen for causing the user to select the storage destination. For example, in a case where image data to be processed is read out from a USB memory and a generated image file is stored in that USB memory, the control section 7 causes the user to select image data to be processed out of the image data stored in the USB memory, and causes the user to set a file name with which the image file having been processed is to be stored.

Thereafter, in response to a press by the user on a start button on the image forming apparatus 1, the control section 7 causes the control section 7 to read a document and generate image data (S2).

Subsequently, the control section 7 causes the character recognition section 31 to carry out the character recognition process on the image data read from the document by the image input apparatus 2 (S3), and also causes the translation section 32 to carry out the translation process with respect to text data of the original text which text data has been generated by the character recognition process (S4).

Thereafter, the control section 7 causes the file information generation section 33 to generate layer information on layers that constitute an image file to be generated later (S5). That is, the image forming apparatus 1 generates a document image layer based on the image data read in S2, a text layer based on a result of the character recognition process carried out in S3, and a translated-word layer and a pop-up layer based on a result of the translation process carried out in S4.

The control section 7 also causes the file information generation section 33 to generate a draw command to be embedded in the image file to be generated later (S6). The draw command generated here includes the initial display command, the button display command, the switch command, the printing prohibition command, and the batch processing command, and the like, which have been described above.

Subsequently, the control section 7 causes the formatting process section 34 to generate (format) an image file in a predetermined format in which image file the layers generated in S5 and the draw command generated in S6 are embedded (S7). Note that in a case where the simple mode is selected, a detection result (the skew angle and whether or not the top-to-bottom direction is appropriate) of the document detection section 14 is embedded in header information of the image file (PDF file).

Then, the control section 7 temporarily stores, in the storage section 6, the image file generated by the formatting process section 34, and then causes the transmitting and receiving section 5 to transmit this image file to a transmission destination which is specified by a user (S8), and the process is ended.

(3) Information Embedded in Image File

The following provides an example of information described (draw command embedded in the image file).

The following discusses information for switching between the pop-up display state as illustrated in (a) of FIG. 4 and the translated-word display state as illustrated in (b) of FIG. 4.

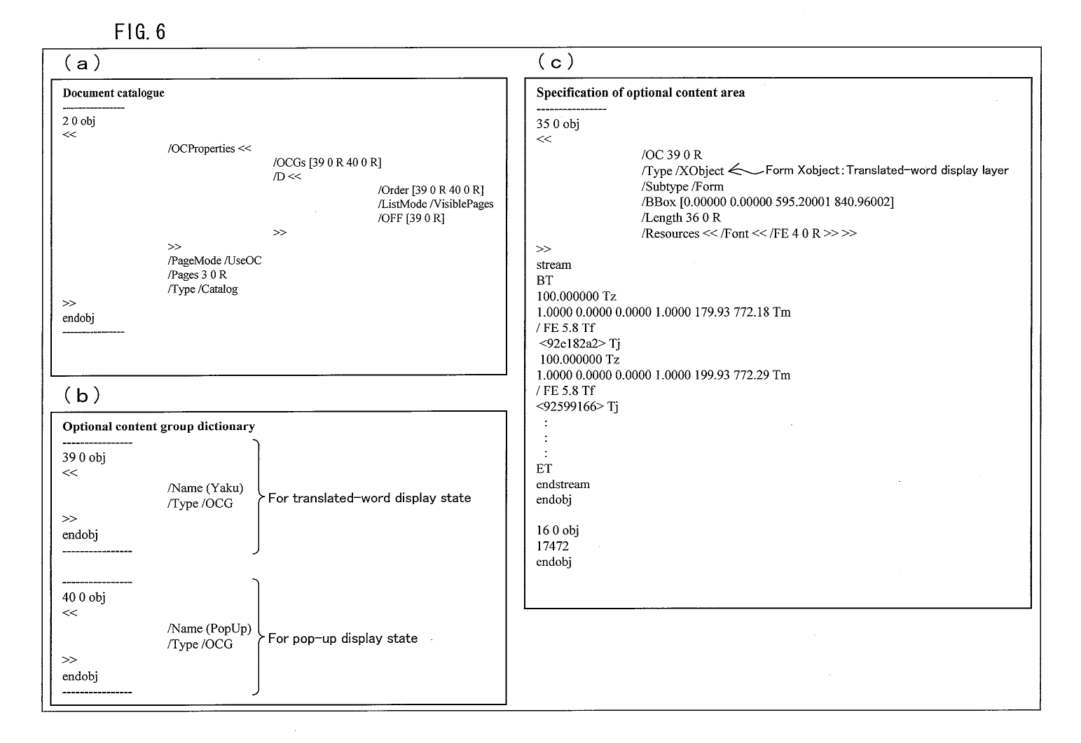

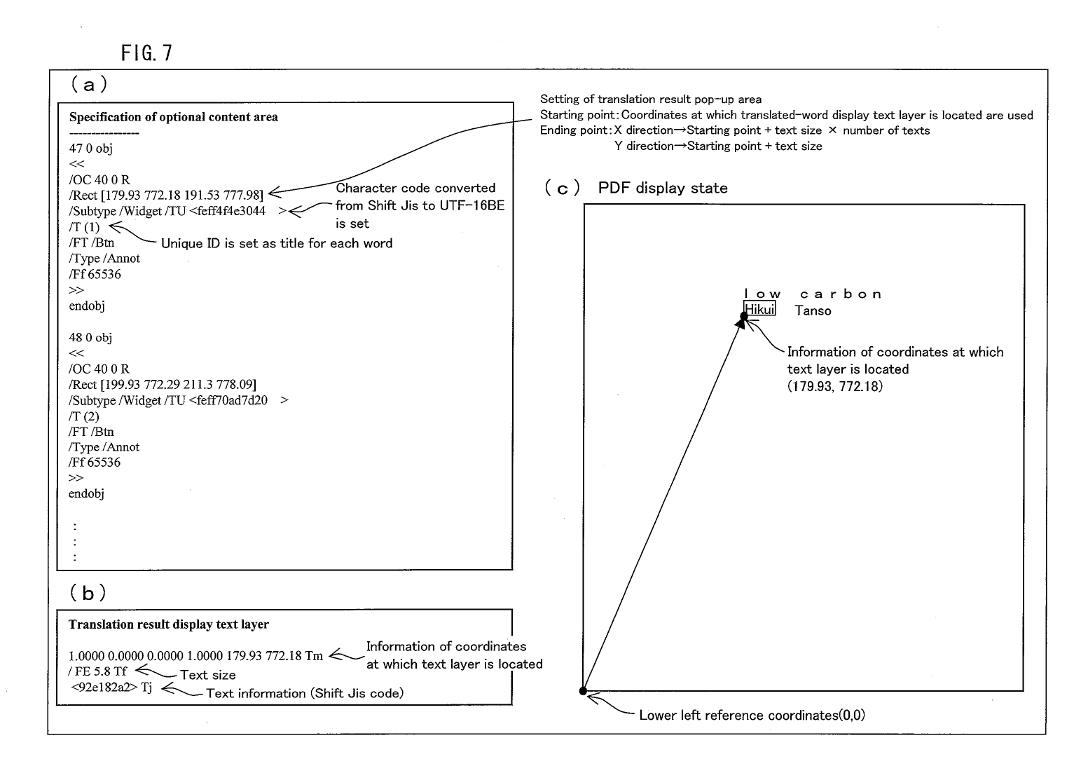

FIGS. 6 and 7 are diagrams each showing an example of information (a draw command), embedded in the image file, for switching between the pop-up display state and the translated-word display state. As illustrated in FIGS. 6 and 7, the information described includes a document catalog, an optional content group dictionary, and specification of an optional content area.

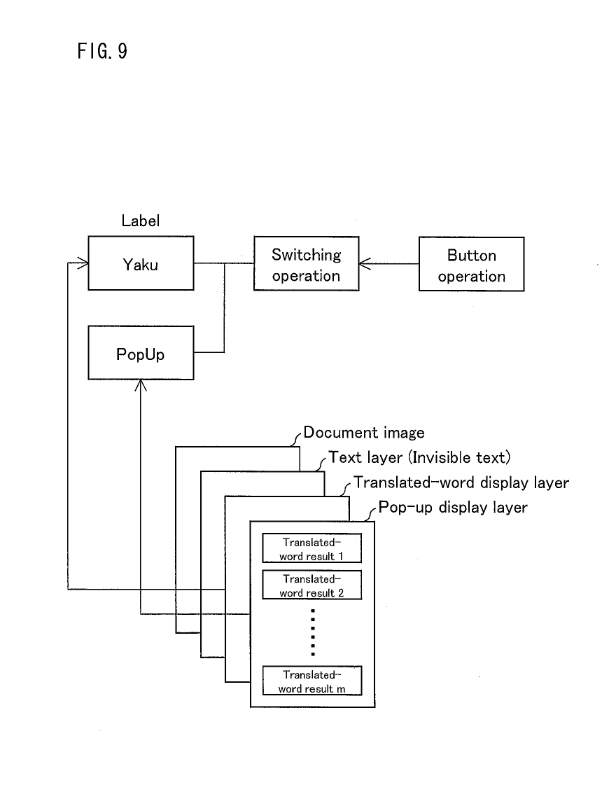

The optional content group dictionary defines a label (see FIGS. 9, 12, and 13) that is used for organizing association between data of the image file and an action to switch between the pop-up display state and the translated-word display state for a case where such an action is carried out. In an example of (b) of FIG. 6, a name and a type of an object “39 0” is defined so that the object “39 0” is used as a switching label for the translated-word display state and the object “40 0” is used as a switching label for the pop-up display state.

The document catalog shows information on an entire document (document image). This document catalog is set, for each page and each object, for an object for which switching is carried out. (a) of FIG. 6 shows an example of a case where two objects “39 0” and “40 0” are displayed. In a default (the initial display state), “39 0” is set to be in the non-display state, and “40 0” is set to be in the display state. That is, the result of translation is displayed in the pop-up display state in the default.

The specification of an optional content area indicates an object indicative of contents information of each page. Examples shown in FIGS. 6 and 7 each indicate an area of an object (result of translation) which is to be subjected to display switching (a text for the translated-word display state and a text for the pop-up display state). Specifically, in an example shown in (c) of FIG. 6, the text for the translated-word display state is set as an area of the object “39 0”. Meanwhile, in an example shown in (a) of FIG. 7, the text for a pop-up display is set as an area of the object “40 0”.

Note that in the specification of an optional content area for the pop-up display, an ID (identification information), a character code, and a pop-up display area (display position) are set for each word included in translated words.

In the example shown in (a) of FIG. 7, a word having an ID of T(1) is set to have a character code in the translated-word layer which character code has been converted from Shift Jis to UTF-16BE. Further, in the example shown in (a) of FIG. 7, a pop-up display area of the word having the ID of T(1) is set in a Widget annotation for the pop-up display by use of coordinates at which the word is located in the translated-word layer.

(b) of FIG. 7 illustrates a part of a description of the translated-word layer, and (c) of FIG. 7 shows an example of the display state in the translated-word display state. As illustrated in (b) and (c) of FIG. 7, in the translated-word layer, a coordinate position on the document is set with reference to a lower left corner of the image data, and a starting point (lower left corner) of a display position of each word is set.

As illustrated in (a) of FIG. 7, in the specification of an optional content area for the pop-up display, a pop-up area (display position) of each word is set by use of coordinates of the translated-word layer. Specifically, a starting point (x coordinate, y coordinate) of the pop-up area of each word is set by use of coordinates of the translated-word layer. In the case of horizontal writing (in a case where successive texts are adjacent to each other in an x direction), an x coordinate of an ending point of the pop-up area of each word is set at a value obtained by adding, to the x coordinate of the starting point, a value obtained by multiplying a text size (size of each text in the x direction) and the number of texts of the word, and a y coordinate of the ending point is set at a value obtained by adding a text size (size of each text in a y direction) to the y coordinate of the starting point. In the case of vertical writing (in a case where successive texts are adjacent to each other in the y direction), the x coordinate of the ending point is set at a value obtained by adding the text size (size of each text in the x direction) to the x coordinate of the starting point, and the y coordinate of the ending point is set at a value obtained by adding, to the y coordinate of the starting point, a value obtained by multiplying the text size (size of each character in the y direction) and the number of texts of the word.

Note that the pop-up layer may be obtained by embedding text information of translates words by use of an annotation function in a PDF specification.

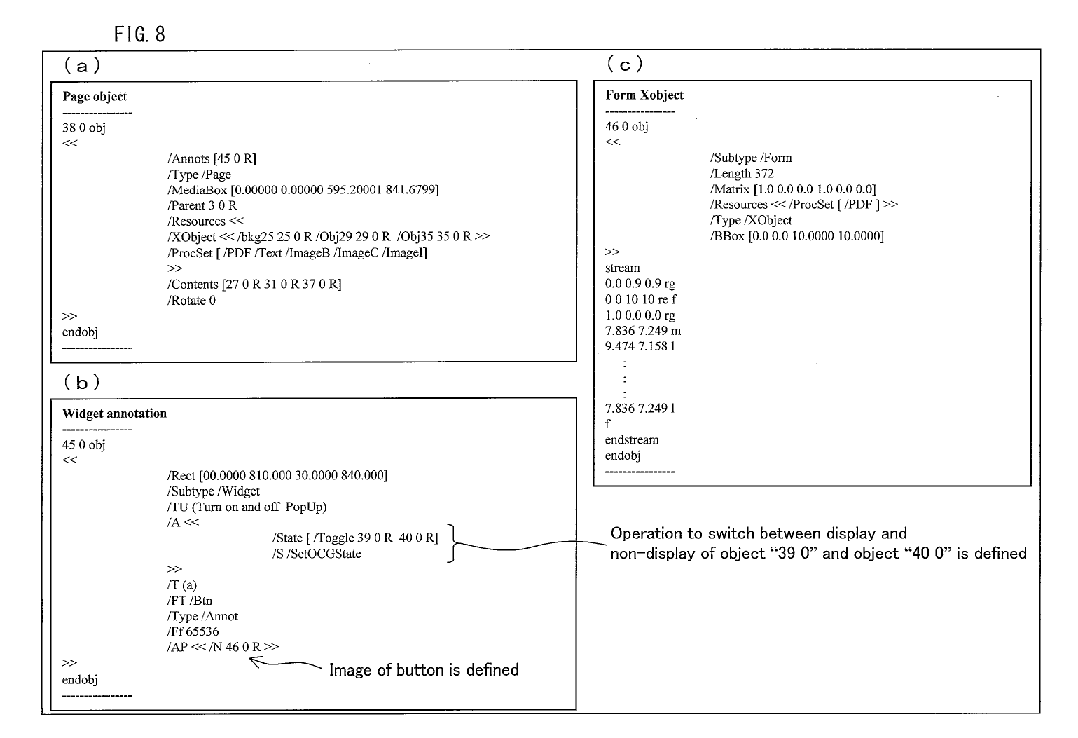

The following description discusses information for displaying a switching button for switching between the pop-up display state and the translated-word display state. FIG. 8 is a diagram illustrating information, embedded in the image file, for displaying the switching button.

(a) of FIG. 8 shows a page object. The page object shows information on each page of a document. The page object also includes reference information for a case where an action (transition to display or non-display, a linked object, or the like) is made. The page object of (a) of FIG. 8 indicates a link to a Widget annotation as illustrated in (b) of FIG. 8.
(b) of FIG. 8 illustrates a Widget annotation that indicates an explanation of an object for which an action is to be made and that indicates that display and non-display of the object “39 0” and the object “40 0” are switched by the switching button. Note that in this example, the switching button is set so that the switching button is not printed (default setting). Further, “/N 46 0 R” specifies reference information to an image of the switching button, and indicates a link to a form XObject (object “46 0”) of (c) of FIG. 8.

(c) of FIG. 8 is a form XObject that defines an appearance of the switching button (a drawing image of the switching button).

FIG. 9 is a diagram showing a relationship between each layer of the image file and a translated-word display state. As illustrated in FIG. 9, each layer constituting the image file is associated with a label (“Yaku”, “PotUp”, etc.). This label is defined by the optional content group dictionary of (b) of FIG. 6. Further, a “switching operation” illustrated in FIG. 9 is defined by the Widget annotation of (b) of FIG. 8. In addition, a “button image” illustrated in FIG. 9 is defined by the form XObject of (c) of FIG. 8.

According to an arrangement of the image file as illustrated in FIGS. 6 through 9, when a user clicks the switching button illustrated in (a) of FIG. 4 or (b) of FIG. 4, the pop-up display state and the translated-word display state are switched each other. Further, in printing in the pop-up display state, only the document image is printed. Meanwhile, in printing in the translated-word display state, the document image and the translated words are printed.

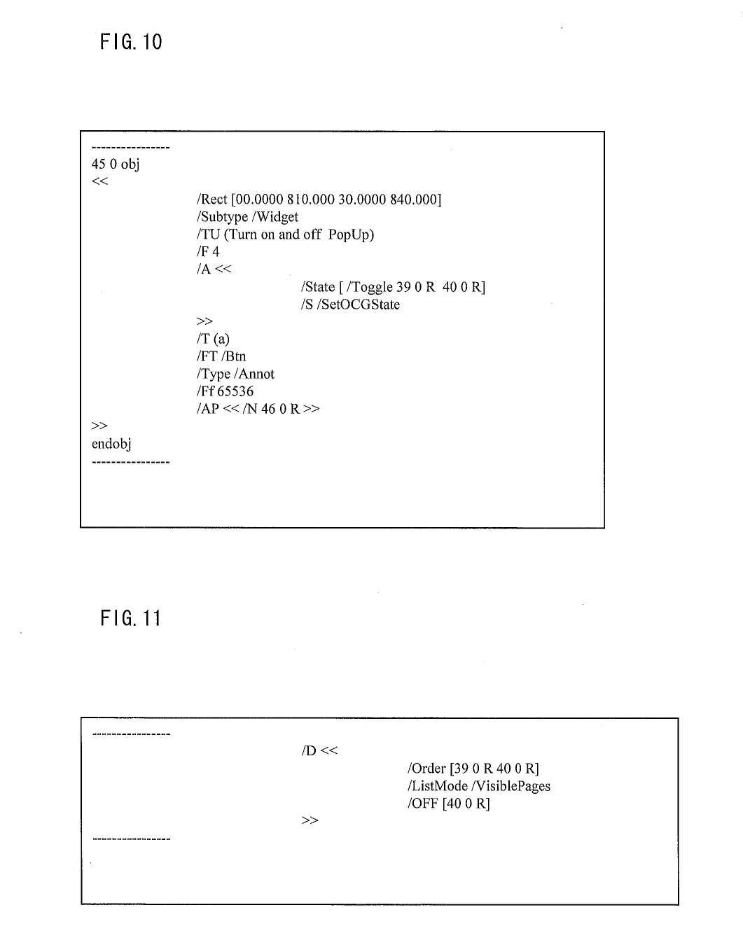

Note that in the present embodiment, the switching button is set not to be printed. However, the present embodiment is not limited to this. By inserting the command “/F4” to the Widget annotation illustrated in (b) of FIG. 8 (see FIG. 10), the switching button can be printed at the time of printing. In a case where a user would like the switching button not to be printed, the command “/F4” should not be inserted in the Widget annotation as illustrated in (b) of FIG. 8.

Further, in the present embodiment, the initial display state in which the image file is opened by a user is set to the pop-up display state. However, the present embodiment is not limited to this. The initial display state in which the image file is opened can be set to the translated-word display state by inserting the command “/OFF [40 0 R]” instead of the command “/OFF [39 0 R]” of the document catalog illustrated in (a) of FIG. 6. Whether the pop-up display state or the translated-word display state is to be set as the initial display state only needs to be specified by a user by use of the operation panel 9 before generation of the image file is started.

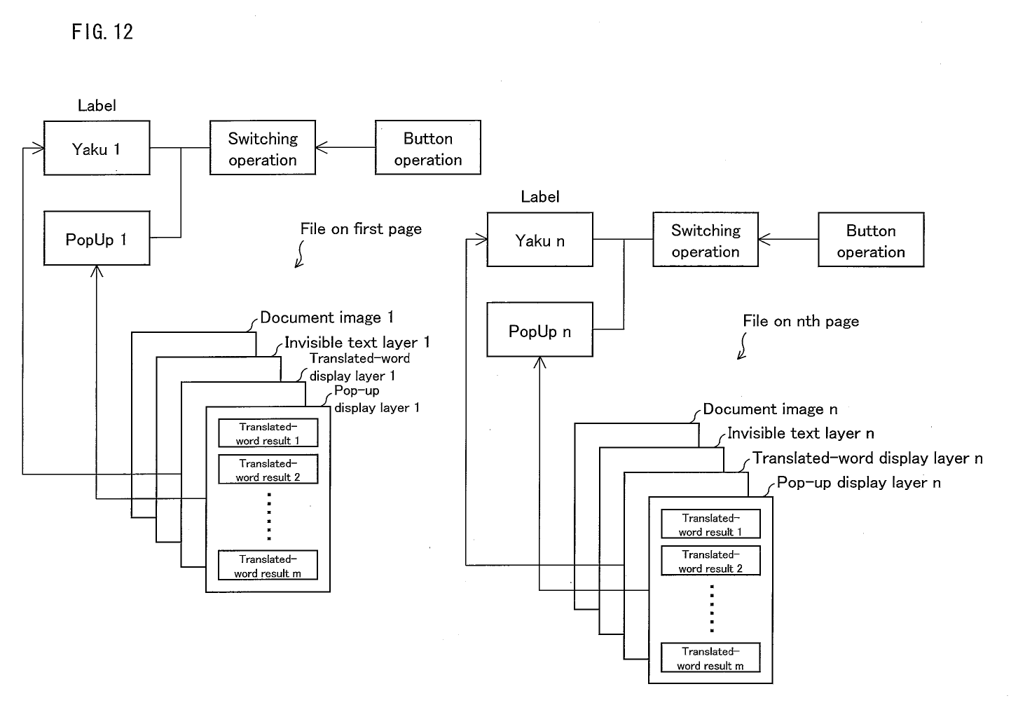

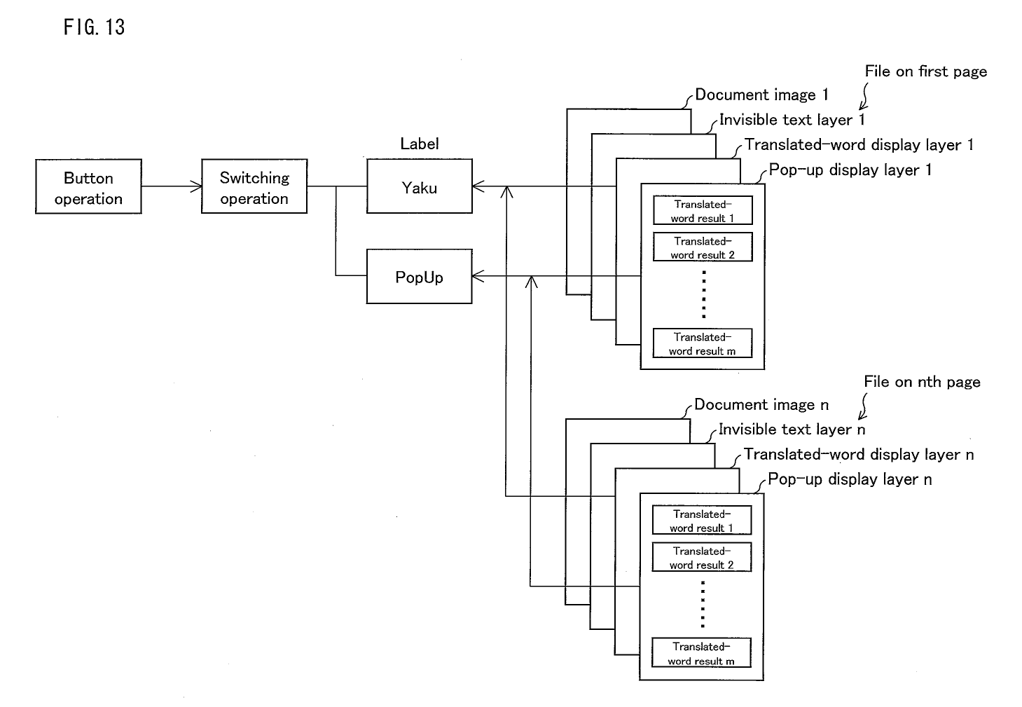

In addition, in the present embodiment, in a case where the pop-up display state and the translated-word display state are to be switched for each page, a different label is defined for each page as illustrated in FIG. 12. Then, for each label, a label and a layer that is to be controlled with this label are associated with each other. In this case, a common embodiment or a different embodiment may be employed for display of the switching button on each page. On the other hand, in a case where the pop-up display state and the translated-word display state are to be switched for all pages in a batch (together), translated-word layers for respective pages are defined as separate objects and all the pages are associated with the same label as illustrated in FIG. 13. In this case, the same embodiment is employed for display of the switching button on all the pages.

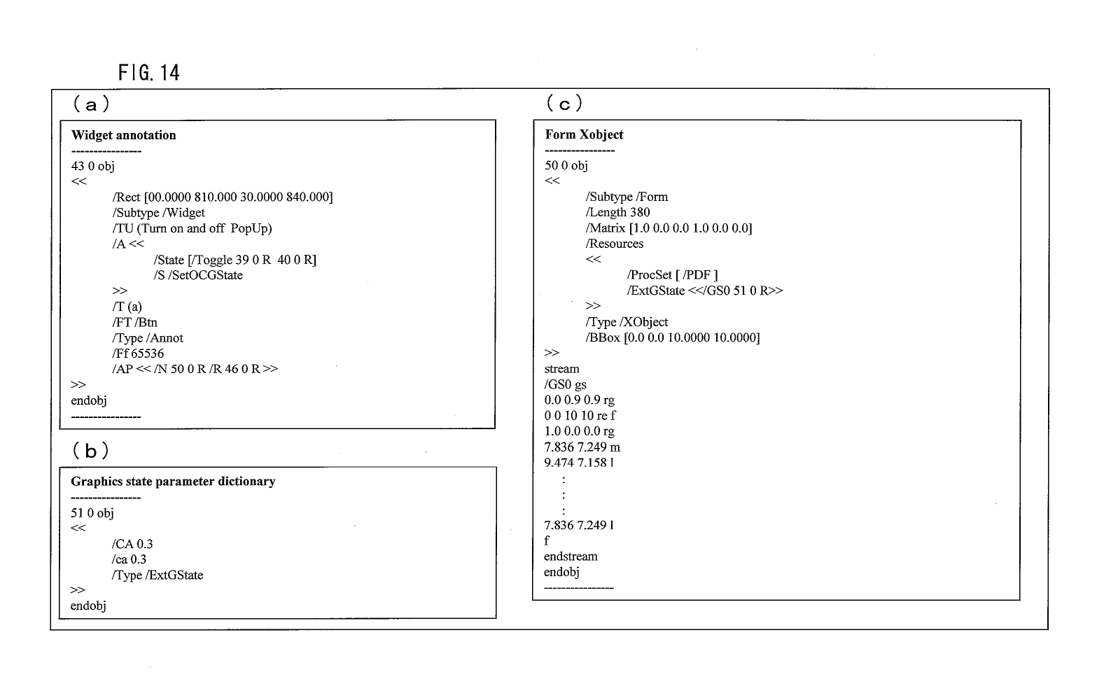

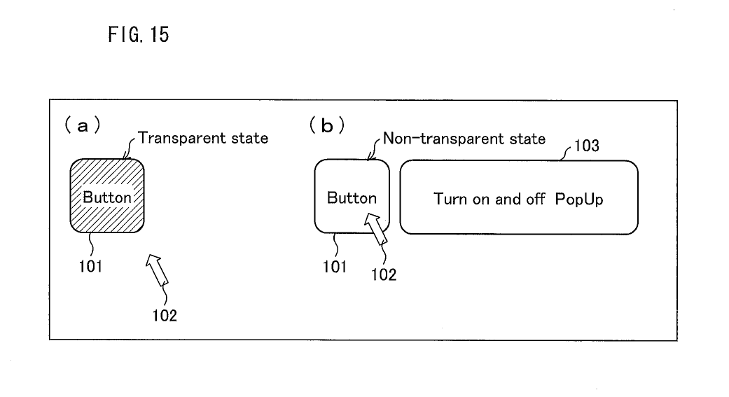

The present embodiment may also be arranged such that, when a user carries out a predetermined operation (e.g., moves the cursor onto the switching button by an operation of a pointing device such as a mouse) while the switching button is being displayed in a transparent state (e.g., at a density that is 30% of a normal density), the switching button is displayed in a non-transparent color at the normal density, or annotation information with respect to the switching button is displayed. (a) through (c) of FIG. 14 are a diagram showing an example of information (a draw command) embedded in the image file in this case. FIG. 15 is a diagram showing an example of a display state of the switching button in accordance with settings of (a) through (c) of FIG. 14.

(a) of FIG. 14, which shows an example of the Widget annotation, specifies that the display state of the object “39 0” and the display state of the object “40 0” are switched by an operation of the switching button. Note that in the example of (a) of FIG. 14, the switching button is set so that the switching button is not printed (default setting).

In the example of (a) of FIG. 14, it is defined that the drawing image of the switching button in a case where the cursor is outside the switching button (normal appearance) is an object “450” (a transparent drawing image), and the drawing image of the switching button in a case where the cursor is inside the switching button (rollover appearance) is an object “44 0” (a non-transparent drawing image, a drawing image having a higher density than the transparent drawing image).

In the example of (a) of FIG. 14, it is defined that, while the cursor is inside the switching button, a dialogue box (explanatory image) explaining a function of the switching button (details of an operation carried out when the switching button is operated) is displayed in a vicinity of the switching button.

Specifically, it is defined that a text string in parentheses “( )” following “/TU”, i.e., a message “Turnon and off PopUP” is displayed. Note that the Widget annotation illustrated in (a) of FIG. 14 indicates a link to a form in which the transparent drawing image of the switching button is described (see (c) of FIG. 14) and a form in which the non-transparent drawing image of the switching button is described (not illustrated).

In (c) of FIG. 14, which shows an example of a form (form XObject) in which the drawing image (appearance) of the switching button is described, the transparent drawing image of the button is defined.

In (b) of FIG. 14, which shows an example of a graphic-state parameter dictionary specifying a drawing state of an object, a transparent drawing state is defined. In the example of (c) of FIG. 14, the transparent state is set to have a non-transparency of 30% (transmittance of 70%).

This allows a switching button 101 to be displayed in a transparent state while a cursor 102 is outside the switching button 101 (see FIG. 15). Further, in a case where the cursor 102 moves to inside the switching button 101, the switching button 101 is displayed in a non-transparent state (display state in which the switching button 101 is displayed at a higher density than in the transparent state), and a dialogue box 103 indicative of the message “Turn on and off PopUp” is displayed in a vicinity of the switching button 101. An operation carried out in a case where a click is made on the switching button 101 is as described earlier.

(4) Example Process on Image Data Inputted from External Device

In the embodiment described above, the image forming apparatus 1 is arranged to carry out printing or transmission based on image data that is inputted from the image input apparatus 2. The image forming apparatus 1 may also have a function of carrying out processes in the image transmitting mode and the printing mode based on an image file that is inputted from an external device. The following discusses an example of a case where a process in the image transmitting mode is carried out based on image data that is inputted from an external device. Note that the external device indicates various storage media such as a USB memory (removable media) inserted into the image forming apparatus 1 or a terminal device communicably connected with the image forming apparatus 1 via a network, etc.

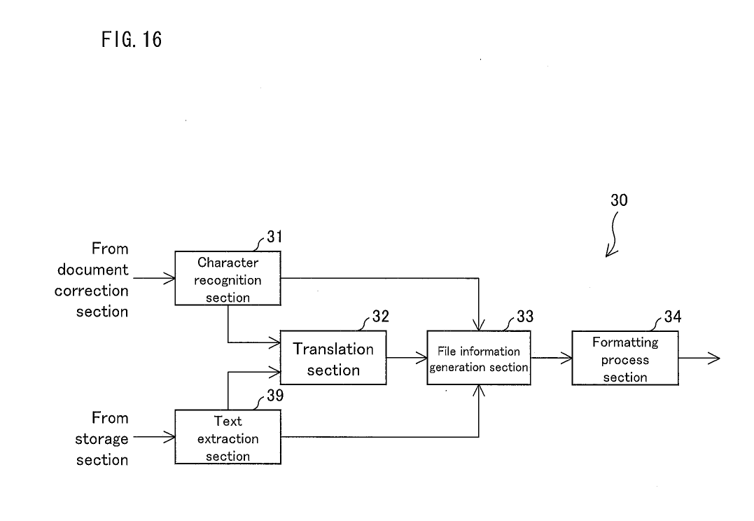

In the present example, an entire arrangement of the image forming apparatus 1 is as illustrated in FIG. 1, except that a configuration of the file generation section 30 of the present example is not a configuration as illustrated in FIG. 3 but a configuration as illustrated in FIG. 16.

The file generation section 30 as illustrated in FIG. 16 includes a character recognition section 31, a translation section 32, a file information generation section 33, a formatting process section 34, and a text extraction section (text information obtaining section) 39. The processing contents of the character recognition section 31, the translation section 32, the file information generation section 33, and the formatting process section 34 are similar to those illustrated in FIG. 3 and therefore, explanations thereof are omitted.

Here, the following discusses a control section 7 before the text extraction section 39 as illustrated in FIG. 16 is explained. In the present example, when the image transmitting mode is selected and an image file stored in the storage section 6 is selected as an object to be processed, the control section 7 determines whether or not text data is embedded in this image file to be processed. Note that the image file to be processed means a file that has been received via a network and the transmitting and receiving section 5 and that is stored in the storage section 6 or a file that has been read from a removable media (memory device) such as a USB memory inserted in the image forming apparatus 1 and that is stored in the storage section 6.

Then, in a case where the control section 7 determines that text data is not embedded in the image file to be processed, the control section 7 extracts image data in the image file and transmits the image data to the character recognition section 31 of FIG. 16 via the encoding/decoding section 8 and the document correction section 15. Then, the character recognition section 31 and blocks subsequent to the character recognition section 31 of FIG. 16 carry out the processes that are the same as those carried out by the character recognition section 31 and blocks subsequent to the character recognition section 31 of FIG. 3. As a result, an image file with translated words is generated.

Meanwhile, in a case where the control section 7 determines that text data is embedded in the image file to be processed, the control section 7 transmits this image file from the storage section 6 to the text extraction section 39.

The text extraction section 39 carries out a process in which (i) image data indicative of a document image and (ii) text data are extracted from the image file, when the image file is received form the storage section 6. Then, the text extraction section 39 outputs the text data extracted, to the translation section 32 and the file information generation section 33, and also outputs the image data extracted, to the file information generation section 33. Then, the translation section 32, the file information generation section 33, and the formatting process section 34 of FIG. 16 carry out the processes that are the same as those carried out in the translation section 32, the file information generation section 33, and the formatting process section 34 of FIG. 3, so that an image file with translated words is generated.

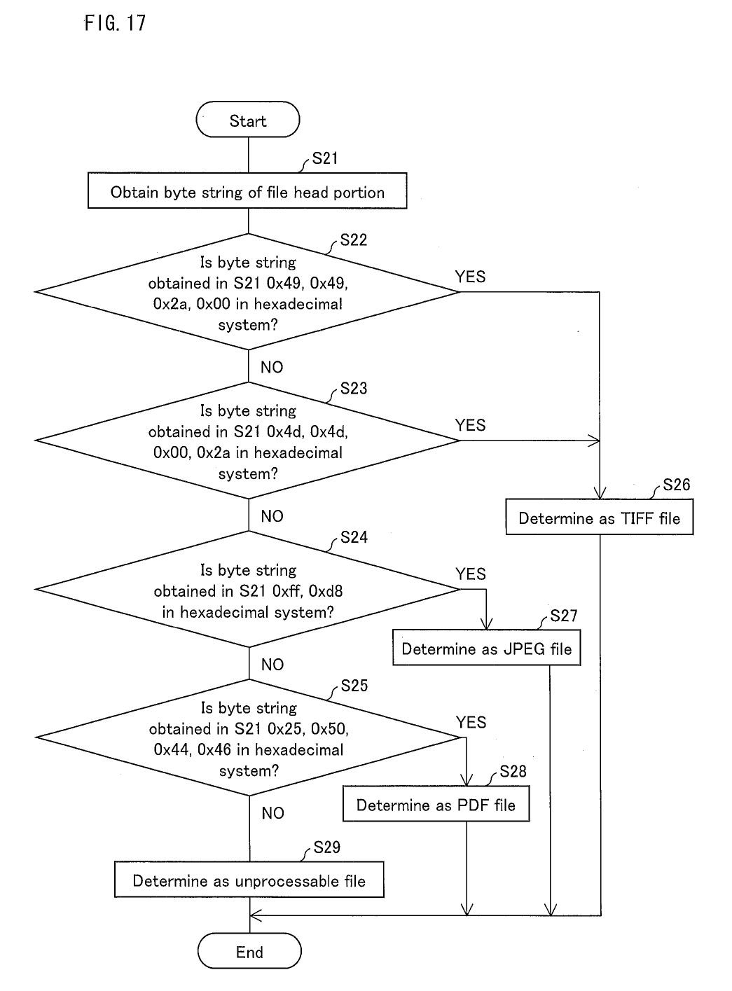

FIG. 17 is a flow chart showing an example of a file format determination process carried out by the control section 7. In the processes illustrated in FIG. 17, a byte string of a file head portion of an image file is checked so that a file type (format) of the image file is simply recognized (In other words, the processes are arranged by putting a focus on a point that various types of image files have, in file head portions (headers), distinctive byte strings in accordance with a file format).

When the image transmitting mode is selected and an image file stored in the storage section 6 (or an image file stored in an external device communicably connected via the transmitting and receiving section 5, or an image file stored in various memory devices detachably connected to a digital color multifunction peripheral 1) is selected as an object to be processed, the control section 7 obtains a byte string in a file head portion of the image file (S21).

In a case where the byte string obtained in S21 is 0X49, 0X49, 0X2A, 0X00 in a hexadecimal system (YES in S22), that is, in a case where the file starts with 0X49, 0X49, 0X2A, 0X00, the control section 7 determines that a format of the image file to be processed is TIFF (S26).

Further, in a case where the byte string obtained in S21 is 0X4D, 0X4D, 0X00, 0X2A in a hexadecimal system (No in S22 but YES in S23), the control section 7 determines that a format of the image file to be processed is TIFF (S26).

Meanwhile, in a case where the byte string obtained in S21 is 0XFF, 0XD8 in a hexadecimal system (No in S22 and S23, but YES in S24), the control section 7 determines that a format of the image file to be processed is JPEG (S27).

In a case where the byte string obtained in S21 is 0X25, 0X50, 0X44, 0X46 in a hexadecimal system (No in S22 to S24, but YES in S25), the control section 7 determines that a format of the image file to be processed is PDF (S28).

On the other hand, in a case where the byte string obtained in S21 is not any of the byte strings shown in S22 to S25 (NO in S22 to S25), the control section 7 determines that the image file to be processed is unprocessable (S29). In this case, the process in the transmitting mode is terminated.

The control section 7 specifies a format of the image file in the processes of FIG. 17. Then, the control section 7 determines the presence/absence of text data as below.

First, in a case where the format specified in the processes of FIG. 17 is PDF, the control section 7 checks a text command so as to determine the presence/absence of text data in this PDF file. For example, in a file format, like a searchable PDF, in which text data is embedded in PDF, a description such as “stream BT 100.000000 Tz . . . ” is present in the PDF file as illustrated in (c) of FIG. 5. Based on such a description, it is possible to determine that text data is embedded. On the other hand, in a case where text information is stored as a bit map image in a PDF file (in a case where the PDF file does not include text data), the above description is not included. Accordingly, it is possible to determine that text data is not embedded.

Meanwhile, in a case where the format specified in the processes of FIG. 17 is JPEG, the control section 7 recognizes the image file as an image file that does not include text data.

Further, in a case where the format specified in the processes of FIG. 17 is TIFF, the control section 7 recognizes the image file as an image file that does not include text data. However, in this case, the control section 7 checks a tag of the TIFF file, and determines whether the TIFF file is a binary image file or a multi-level image file. Then, in a case where the TIFF file is a multi-level image file, the control section 7 extracts image data included in the TIFF file, converts the image data into RGB image data and then outputs the RGB image data to the file generation section 30 via the document correction section 15. On the other hand, in a case where the TIFF file is a binary image file, the control section 7 extracts a binary image included in the TIFF file and causes the encoding/decoding section 8 to carry out a process in which the binary image is converted into multi-level RGB image data (e.g., 8-bit image data). Then, the RGB image data subjected to the conversion is outputted to the file generation section 30 via the document correction section 15.

Note that although the example process shown in FIG. 17 has no discussion of a case where the image file to be processed is electronic data such as word data, excel data, or power point data in the above embodiment of processing, such electronic data also contains text data. Accordingly, in a case where an image file to be processed is such electronic data, the control section 7 inputs the electronic data into the file generation section 30.

(5) Example of Image Reading Apparatus

The present embodiment discusses a case where the present invention is applied to a color image forming apparatus. However, the present invention is not limited to this arrangement. The present embodiment may be applied to a monochrome image forming apparatus. Further, the present invention may be applied not only to an image forming apparatus but also to an individual color image reading apparatus, for example.

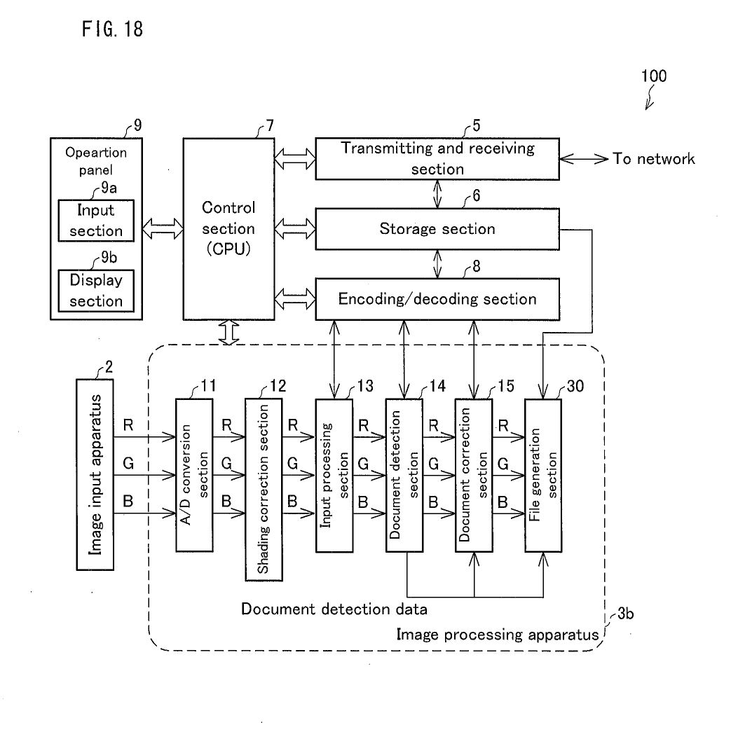

FIG. 18 is a block diagram illustrating an example arrangement in a case where the present invention is applied to a color image reading apparatus (hereinafter, referred to as an “image reading apparatus”). As illustrated in FIG. 18, the image reading apparatus 100 includes an image input apparatus 2, an image processing apparatus 3b, a transmitting and receiving section 5, a storage section 6, a control section 7, an encoding/decoding section 8, and an operation panel 9. The image input apparatus 2, the transmitting and receiving section 5, the storage section 6, the control section 7, the encoding/decoding section 8, and the operation panel 9 have the same arrangement and function as those in the image forming apparatus 1 as described above, respectively, and therefore, explanations thereof are omitted.

The image processing apparatus 3b includes an A/D conversion section 11, a shading correction section 12, an input processing section 13, a document detection section 14, a document correction section 15, and a file generation section 30. The file generation section 30 has an internal configuration that is illustrated in FIG. 3 or 16. The processing contents of respective sections in the image input apparatus 2 and the image processing apparatus 3b are similar to those in the image forming apparatus 1 illustrated in FIG. 1. An image file having been subjected to the above processes in the image processing apparatus 3b is outputted to a computer, a hard disk, a network, or the like.

(6) Software Implementation Example

The control section 7 and/or the file generation section 30 of the image forming apparatus 1 or the image reading apparatus 100 may be realized by a logic circuit (hardware) provided in an integrated circuit (IC chip) or may be realized by software as executed by a CPU (Central Processing Unit).

In the latter case, the image forming apparatus 1 or the image reading apparatus 100 includes: a CPU that executes instructions of a program realizing the foregoing functions; ROM (Read Only Memory) storing the program; RAM (Random Access Memory) that develops the program; and a storage device (storage medium) storing the program and various kinds of data. A storage medium which computer-readably stores program codes (an executable program, an intermediate code program, and a source program) of a control program of the image forming apparatus 1 or the image reading apparatus 100 which control program is software realizing the foregoing functions is supplied to the image forming apparatus 1 or the image reading apparatus 100, so that a computer (or a CPU or an MPU) of the image forming apparatus 1 or the image reading apparatus 100 reads out and implements the program codes stored in the storage medium. The object of the present invention is thus attainable.

The storage medium may be a non-transitory tangible medium. Examples of the non-transitory tangible medium include (i) tapes such as a magnetic tape and a cassette tape, (ii) disks including magnetic disks such as a floppy (Registered Trademark) disk and a hard disk, and optical disks such as a CD-ROM, an MO, an MD, a DVD, and a CD-R, (iii) cards such as an IC card (including a memory card) and an optical card, (iv) semiconductor memories realized by a mask ROM, EPROM, EEPROM (Registered Trademark), and a flash ROM, and (v) logic circuits such as a PLD (programmable logic device) and an FPGA (field programmable gate array).

The image forming apparatus 1 or the image reading apparatus 100 can be connected to a communication network, via which the program codes can be made available to the image forming apparatus 1 or the image reading apparatus 100. Such a communication network is not particularly limited provided that the communication network enables transmission of the program codes. Examples of a usable communication network includes the Internet, an intranet, an extranet, a LAN, ISDN, VAN, a CATV communications network, a virtual private network, a telephone network, a mobile telecommunications network, and a satellite communication network. Further, a transmission medium of which a communication network is composed is not particularly limited to a transmission medium having a specific structure or kind, provided that the transmission medium enables transmission of the program codes. Examples of a usable transmission medium includes wired transmission media such as IEEE1394, a USB, a power-line carrier, a cable TV circuit, a telephone line, and ADSL (Asymmetric Digital Subscriber Line) and wireless transmission media such as infrared communication systems such as IrDA and a remote controller, Bluetooth (Registered Trademark), IEEE802.11 wireless communication system, HDR (High Data Rate), NFC (Near Field Communication), DLNA (Digital Living Network Alliance), a mobile phone network, a satellite circuit, and a digital terrestrial network. Note that the present invention can also be realized in a form of a computer data signal in which the program codes are embodied by electronic transmission and which is embedded in carrier waves.

(7) Working Effects (Advantages) Yielded by Image Processing Apparatus 3

As described earlier, an image processing apparatus 3 of the present embodiment includes: a text information obtaining section (a character recognition section 31 and/or a text extraction section 39) configured to obtain text information of an original text contained in an image corresponding to image data; a translation section 32 configured to generate translation information of the original text by carrying out a translation process with respect to the original text in accordance with the text information; a draw command generation section (file information generation section 33) configured to generate a draw command indicative of details of processes which are carried out by a computer so as to display the image corresponding to the image data; and a formatting process section 34 configured to generate an image file in a predetermined format which image file contains the image data, the translation information, and the draw command, the draw command generated by the draw command generation section (file information generation section 33), including a draw command for causing the computer to carry out a process for switching, in accordance with an instruction from a user, between a first display state in which the original text is displayed while the translation information is not displayed, and in a case where the user specifies a part of the original text, the original text and the translation information corresponding to the part of the original text, which part is specified by the user, are displayed; and a second display state in which the original text and the translation information corresponding to the original text are displayed at all times.

According to the arrangement, the draw command generated by the draw command generation section includes a draw command for causing the computer to carry out a process for switching, in accordance with an instruction from a user, between (i) a first display state in which the original text is displayed while the translation information is not displayed, and in a case where the user specifies a part of the original text, the original text and the translation information corresponding to the part of the original text, which part is specified by the user, are displayed; and (ii) a second display state in which the original text and the translation information corresponding to the original text are displayed at all times. The formatting process section generates an image file in a predetermined format which image file contains the text information of the original text contained in the image data, the text information being obtained by the text information obtaining section, the translation information of the original text which translation information is generated by the translation section, and the draw command which is generated by the draw command generation section.

This allows a user who browses an image file to generate the image file in which a display state can be easily switched between the first display state and the second display state in accordance with user's preference and an intended use of the image file. Accordingly, it is possible to provide an image file that is easy for a user to use and browse.

The draw command generated by the draw command generation section may be arranged to include: a first draw command for causing the computer to carry out a process for displaying not only the image corresponding to the image data but also a display switching button for causing the user to give an instruction on switching between the first display state and the second display state; and a second draw command for causing the computer to carry out a process for, even in a case where a print instruction is given in a state in which not only the image corresponding to the image data but also the display switching button is displayed, printing the image corresponding to the image data without printing the display switching button.

The arrangement makes it possible to enhance convenience for the user by displaying the display switching button, which is to be operated for switching between the first display state and the second display state while browsing the image file by use of a display device. Further, in a case where the display switching button is not to be printed during printing, it is possible to prevent unnecessary information from being printed.

The draw command generated by the draw command generation section may be arranged to include a third draw command for causing the computer to carry out a process for, in a case where the image corresponding to the image data is made of a plurality of pages, displaying the display switching button together with the image on each of the plurality of pages; and in a case where the user inputs the instruction on switching between the first display state and the second display state by use of the display switching button, applying, to each image on each of the plurality of pages, a process, carried out in response to the input of the instruction, for switching between the first display state and the second display state.

According to the arrangement, in a case where the display switching button corresponding to any one of the plurality of pages is operated, it is possible to apply, to each of the plurality of pages, switching of the display state, which switching corresponds to the operation. This makes it possible to enhance convenience for the user.

The draw command generated by the draw command generation section may be arranged to include a fourth draw command for causing the computer to carry out a process for, in an initial state, displaying the display switching button in a transparent state so that the user can view an image that is displayed so as to be superimposed on the display switching button; and in a case where the user carries out a predetermined operation, causing the display switching button to have a higher density than in the initial state.

According to the arrangement, in a case where the display switching button is displayed in the transparent state except when the user uses the display switching button, it is possible to prevent the display switching button from blocking browsing of the image. Further, in a case where the user uses the display switching button and carries out a predetermined operation, the display switching button can be displayed so as to be easily viewed. Note that examples of the predetermined operation include an operation to superimpose a cursor on the display switching button by use of a pointing device such as a mouse.

The text information obtaining section may be arranged to have at least one of a function of, by carrying out a character recognition process with respect to the image data, obtaining the text information of the original text contained in the image data; and a function of obtaining the text information of the original text by extracting the text information of the original text contained in the image data, the text information being added to the image data.

The arrangement makes it possible to easily obtain the text information of the original text contained in the image data.

The draw command generated by the draw command generation section may be arranged to include: a fifth draw command for causing the computer to carry out a process for, in a case where, during a period in which the original text is displayed in the first display state, the user carries out an operation to place a cursor of a pointing device over a part of the original text displayed, displaying not only the original text but also the translation information corresponding to the part of the original text, over which part the cursor is placed by the user.

According to the arrangement, by placing the cursor of the pointing device over a part of the original text which part has a translated word that the user wishes to check, the user can easily display the translated word of the part.

An image forming apparatus of the present invention includes any one of the image processing apparatuses described above.

The arrangement allows a user who browses an image file to generate the image file in which a display state can be easily switched between the first display state and the second display state in accordance with a scene of use of the image file. Accordingly, it is possible to provide an image file that is easy for a user to use and browse.

The image processing apparatus of the present invention may be realized by a computer. In this case, the scope of the present invention encompasses a program for causing the computer to operate as the sections described above to realize the image processing apparatus by the computer, and a non-transitory computer-readable storage medium storing the program.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is applicable to an image processing apparatus having a function of translating an original text contained in an image corresponding to image data, an image forming apparatus, a program, and a storage medium storing the program.

### REFERENCE SIGNS LIST

1 Image forming apparatus
2 Image input apparatus
3 Image processing apparatus
3b Image processing apparatus
4 Image output apparatus
5 Transmitting and receiving section
6 Storage section
7 Control section
9 Operation panel
9a Input section
9b Display section
30 File generation section
31 Character recognition section (text information obtaining section)
32 Translation section
33 File information generation section (draw command generation section)
34 Formatting process section
39 Text extraction section (text information obtaining section)
100 Image reading apparatus

1. An image processing apparatus comprising:
a text information obtaining section configured to obtain text information of an original text contained in an image corresponding to image data;
a translation section configured to generate translation information of the original text by carrying out a translation process with respect to the original text in accordance with the text information;
a draw command generation section configured to generate a draw command indicative of details of processes which are carried out by a computer so as to display the image corresponding to the image data; and
a formatting process section configured to generate an image file in a predetermined format which image file contains the image data, the translation information, and the draw command,
the draw command generated by the draw command generation section, including a draw command for causing the computer to carry out a process for switching, in accordance with an instruction from a user, between a first display state in which the original text is displayed while the translation information is not displayed, and in a case where the user specifies a part of the original text, the original text and the translation information corresponding to the part of the original text, which part is specified by the user, are displayed; and a second display state in which the original text and the translation information corresponding to the original text are displayed at all times.

2. The image processing apparatus as set forth in claim 1, wherein the draw command generated by the draw command generation section includes: a first draw command for causing the computer to carry out a process for displaying not only the image corresponding to the image data but also a display switching button for causing the user to give an instruction on switching between the first display state and the second display state; and a second draw command for causing the computer to carry out a process for, even in a case where a print instruction is given in a state in which not only the image corresponding to the image data but also the display switching button is displayed, printing the image corresponding to the image data without printing the display switching button.

3. The image processing apparatus as set forth in claim 2, wherein the draw command generated by the draw command generation section includes a third draw command for causing the computer to carry out a process for, in a case where the image corresponding to the image data is made of a plurality of pages, displaying the display switching button together with the image on each of the plurality of pages; and in a case where the user inputs the instruction on switching between the first display state and the second display state by use of the display switching button, applying, to each image on each of the plurality of pages, a process, carried out in response to the input of the instruction, for switching between the first display state and the second display state.

4. The image processing apparatus as set forth in claim 2, wherein the draw command generated by the draw command generation section includes a fourth draw command for causing the computer to carry out a process for, in an initial state, displaying the display switching button in a transparent state so that the user can view an image that is displayed so as to be superimposed on the display switching button; and in a case where the user carries out a predetermined operation, causing the display switching button to have a higher density than in the initial state.

5. The image processing apparatus as set forth in claim 1, wherein the text information obtaining section has at least one of a function of, by carrying out a character recognition process with respect to the image data, obtaining the text information of the original text contained in the image data; and a function of obtaining the text information of the original text by extracting the text information of the original text contained in the image data, the text information being added to the image data.

6. The image processing apparatus as set forth in claim 1, wherein the draw command generated by the draw command generation section includes a fifth draw command for causing the computer to carry out a process for, in a case where, during a period in which the original text is displayed in the first display state, the user carries out an operation to place a cursor of a pointing device over a part of the original text displayed, displaying not only the original text but also the translation information corresponding to the part of the original text, over which part the cursor is placed by the user.

7. An image forming apparatus comprising the image processing apparatus as set forth in claim 1.

8. A non-transitory computer-readable storage medium storing a program for causing the image processing apparatus as set forth in claim 1 to operate.
